(19) United States
(12) Patent Application Publication
(10) Pub. No.: US 2022/0184700 A1
(43) Pub. Date: Jun. 16, 2022

(54) SENSOR CONSTRUCTION AND METHOD FOR MANUFACTURING AN ARTICLE WITH AN EMBEDDED SENSOR

(71) Applicant: TEKNOLOGIAN TUTKIMUSKESKUS VTT OY, Espoo (FI)

(72) Inventors: Risto KUIVANEN, Tampere (FI); Pasi PUUKKO, VTT (FI); Antti VAAJOKI, VTT (FI); Kimmo RUUSUVUORI, VTT (FI); Alejandro REVUELTA, VTT (FI)

(73) Assignee: TEKNOLOGIAN TUTKIMUSKESKUS VTT OY, Espoo (FI)

(21) Appl. No.: 17/601,172

(22) PCT Filed: Apr. 3, 2020
(86) PCT No.: PCT/FI2020/050217

§ 371 Date: Oct. 4, 2021

(30) Foreign Application Priority Data
Apr. 4, 2019 (FI) 20195274

(51) Int. Cl. B22F 7/08; B33Y 10/00; B33Y 80/00; B22F 10/28; G01D 21/02

(52) U.S. Cl. CPC B22F 7/08; B33Y 10/00; G01D 21/02; B22F 10/28; B33Y 80/00

(57) ABSTRACT

Sensor construction (1), which construction comprises a sensor (2), wherein the sensor construction (1) comprises a heat insulating material cover (3) for embedding the sensor construction inside metal material of a component (10), inside which heat insulating material cover the sensor is located, and which heat insulating material cover comprises a level surface section for correct positioning of the sensor construction inside the component during powder bed fusion additive manufacturing process of the component, and a hole (4) extending as a substantially straight channel from the outer surface of the heat insulating material cover to the sensor inside the heat insulating material cover. The invention also relates to a method for manufacturing an article with such a sensor construction (1) embedded.

The present invention relates to a sensor construction suitable for embedding within articles manufactured with additive manufacturing process, and to a method for manufacturing an article with a such embedded sensor with additive manufacturing process.

Embedding sensors to metal articles, especially during the manufacture of the metal articles is problematic, mainly due to the high melting temperatures generally required for formation of solid articles, which high melting temperatures are typically too high for sensors to be embedded to withstand.

However, metallic components with embedded sensors or smart parts are often beneficial means for monitoring harsh environments and the condition of the components in these environments. The application fields include, among others, energy, biomedical, automotive and aerospace industries.

The present invention provides a solution for embedding sensors to metal articles during their manufacturing processes wherein the high manufacturing temperatures do not destroy the embedded sensors.

In the present invention the sensor to be embedded is first placed inside a heat insulating material cover, which cover protects the sensor itself from the heat of the additive manufacturing process of the metal article to be manufactured. The sensor construction comprising the sensor and its heat insulating cover is inserted inside the metal article to be manufactured during the article's additive manufacturing process into a space formed inside the metal article. The heat insulating cover and the manufactured article advantageously also comprises substantially parallel and concentric holes allowing access to the sensor from the outer surface of the manufactured article. Through these holes suitable data transmitting means, such as RFID antenna added on the outer surface of the article for wireless data transfer or data transfer wiring for example, can be connected to the sensor for transporting the collected data from the sensor to outside the article.

The present invention allows the sensor data to be collected and utilized for surveying the condition and environment of the manufactured article.

The present invention provides a sensor construction, which construction comprises a sensor and a heat insulating material cover for embedding the sensor construction inside metal material of a component, inside which heat insulating material cover the sensor is located, and which heat insulating material cover comprises a level surface section for correct positioning of the sensor construction inside the component during powder bed fusion additive manufacturing process of the component, and a hole extending as a substantially straight channel from the outer surface of the heat insulating material cover to the sensor inside the heat insulating material cover.

The heat insulating material cover provides a sufficient heat insulation against the heat of the melted metal material during articles additive manufacturing process so that the sensor does not get destroyed or damaged during the articles manufacturing process. Further, the level surface section of the sensor construction allows proper positioning of the sensor construction and the sensor itself inside the metal article manufactured, especially in view of the provided hole in the heat insulating material cover, so that the hole can provide access to the sensor from the outer surface of the article to be manufactured together with corresponding hole in the article to be manufactured. The heat insulating material cover may also comprise a plurality of holes, and the article to be manufactured the corresponding plurality of holes, for access to the sensor.

In an embodiment of the sensor construction of the invention the heat insulating material cover is formed from two or more parts, which parts are assembled together to form the heat insulating material cover, during which assembling the sensor is inserted inside the heat insulating material cover. This embodiment allows the heat insulating material cover for the sensor the be formed from premanufactured cover parts.

Alternatively, in an embodiment of the sensor construction of the invention the heat insulated material cover is formed as a single piece with additive manufacturing process, during which manufacturing process the sensor is inserted inside the heat insulating material cover. In this embodiment the temperature of the additive manufacturing process of the heat insulating material cover must be sufficiently low so that the sensor can withstand it without damage. Further, the insertion of the sensor inside the material cover typically requires interruption of the additive manufacturing process of the cover.

In an embodiment of the sensor construction of the invention on the level surface section of the heat insulating material is added a metal layer. The metal layer is preferably in the form of a sheet metal piece or metal coating. This metal layer provides better surface for adhesion and heat dissipation for the continued powder bed fusion additive manufacturing process after the sensor construction is inserted at its place in the manufacture of an article comprising the sensor construction.

In an embodiment of the sensor construction of the invention the heat insulating material is ceramics, such as aluminum oxide (Al₂O₃) or zirconia (ZrO₂) for example.

In an embodiment of the sensor construction of the invention the heat insulating material cover comprises a spherical section. This spherical section can be utilized is proper position adjusting of the sensor construction in the corresponding space during the inserting of the sensor construction into the said space in the manufactured article.

In an embodiment of the sensor construction of the invention the sensor is MEMS (Micro Electro Mechanical Systems) sensor. The variables to be measured with the sensor include acceleration, temperature, vibrations and/or acoustic emission, for example.

In an embodiment of the sensor construction of the invention the sensor construction comprises devices for transmitting data from the sensor, such as a RFID antenna, which devices are located outside the heat insulating material cover and connected to the sensor via the straight hole in the heat insulating material cover. Alternatively, suitable Short Range Radio Device Communications (SRD) devices, Long range radio devices, such as Lora and Sigfox, or infrared data transfer devices, for example, may be used for transmitting data from the sensor to a suitable external receiver. Further, the data transfer from the sensor can also be embodied with simple wiring in suitable applications.

The present invention also provides a method for embedding a sensor inside an article, in which method the article is manufactured with a powder bed fusion additive manufacturing process from metal material, wherein
the sensor is a sensor of a sensor construction of the above-mentioned type with a level surface section,
in the article manufactured is formed a space for the sensor construction, which space corresponds the shape and size of the sensor construction,
the additive manufacturing process is interrupted when the space for the sensor construction is formed with the exception of its upper surface,
the sensor construction is inserted in the formed space so that the sensor construction fills substantially the whole formed space, and its level surface section is substantially flush with the manufacturing surface of the article, and the additive manufacturing process is continued until the article (10) is ready,
during the additive manufacturing process of the article a substantially straight hole is formed, which hole extends from the space for the sensor construction to the outer surface of the article, and which hole in the manufactured article is substantially parallel and concentric with the hole in the sensor construction inside the article, and
data transmitting devices are connected to the sensor via the hole in the article and the hole in the sensor construction.

In the method of the invention the powder bed fusion additive manufacturing process of the metal article is preferably selective laser melting (SLM) or direct metal laser sintering (DMLS). The metal material of the article to be manufactured can be stainless steel AlSI 316L or tool steel H13, for example.

In an embodiment of the method of the invention the accuracy of the dimensioning of the space for the sensor construction is less than the powder thickness of the powder bed fusion additive manufacturing process.

More precisely the features defining a sensor construction in accordance with the present invention are presented in claim 1, and the features defining a method of the invention are more precisely presented in claim 8. Dependent claims present advantageous features and embodiments of the invention.

Exemplifying embodiment of the invention and its advantages are explained in greater detail below in the sense of example and with reference to accompanying drawings, where

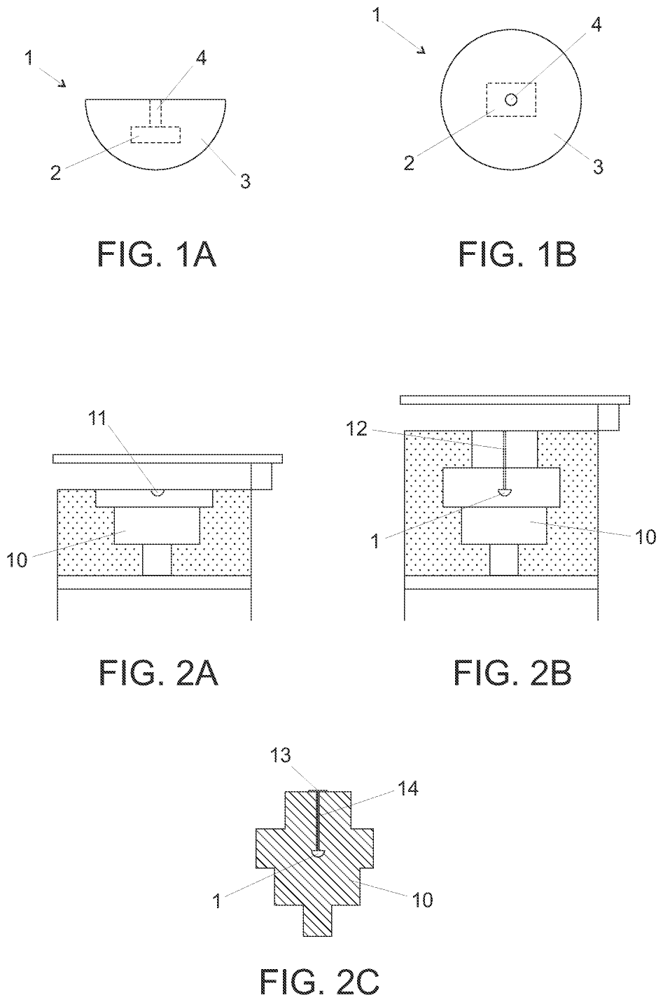

FIGS. 1A and 1B show schematically an embodiment of a sensor construction of the invention, and

FIGS. 2A-2C show schematically the stages of an embodiment of a method of the invention.

In FIGS. 1A and 1B is shown schematically a sensor construction 1 in accordance with the present invention, where FIG. 1A shows the sensor construction as a side view and FIG. 1B shows the sensor construction as a top view.

The sensor construction of FIGS. 1A and 1B comprises the sensor 2 itself embedded inside a heat insulating material cover 3, which cover is in this embodiment manufactured from ceramics with an additive manufacturing process. During the manufacturing of the heat insulating material cover 3 a hole 4 extending from the level upper surface of the sensor construction 1 to the sensor 2 is formed. The hole 4 allows access to the sensor 2 from outside of the sensor construction for connecting further devices (not shown) to sensor, such as a RFID antenna or other suitable data transmitting devices, or a power source, for example.

The sensor 2 is in this embodiment a MEMS (Micro Electro Mechanical Systems) sensor, which is very suitable for the embedding due to its small size. The sensor 2 is preferably adapted to measure acceleration, temperature, vibrations and/or acoustic emission, for example.

The heat insulating material cover 3 of the sensor construction 1 can also be manufactured as a two or more pieces, which are assembled around the sensor 2 in an additional manufacturing step.

As can be seen from FIG. 1A, the outer surface of the heat insulating material cover 3 comprises a level top surface with the hole 4, which top surface is utilized to provide a level surface for continued manufacturing of an article once the sensor construction 1 is inserted in the article. The spherical portion of the outer surface of the insulating material cover 3 allows easy adjustment of the position of the sensor construction during its insertion into a corresponding hole or opening in the article to be manufactured.

The level top surface of the insulating material cover 3 may also be equipped with a metal layer (not shown), such as a metal piece or a metal coating, which metal layer provides better surface for adhesion and heat dissipation for the continued powder bed fusion additive manufacturing process after the sensor construction 1 is inserted at its place in the manufacture of an article comprising the sensor construction.

The material of the heat insulating material cover 3 is in this embodiment formed from ceramic material, such as aluminum oxide (Al₂O₃) or zirconia (ZrO₂) for example.

In FIGS. 2A-2C is shown the main phases of the manufacturing process of an article 10 in accordance with the present invention. In the process shown in these figures the article 10 is manufactured with a powder bed fusion additive manufacturing process from metal material, such as stainless steel 316L or tool steel H13 for example. The powder bed fusion additive manufacturing process used in this embodiment is selective laser melting (SLM).

In the situation of FIG. 2A the manufacturing process of the article 10 is interrupted in a phase, where the space 11 for the sensor construction 1 shown in FIGS. 1A-1B is formed as an open slot which corresponds the shape of the sensor construction with open upper surface. The sensor construction 1 is inserted and properly positioned at the space 11 at this stage. The level upper surface of the sensor construction 1 provides level surface for the powder when the continued additive manufacturing process for further formation of the article 10 to be manufactured. The space 11 is preferably emptied of any powder of the powder bed fusion process before the inserting of the sensor construction 1 therein.

The space 11 is preferably very accurately dimensioned having the dimensional accuracy of less than the powder thickness of the powder bed fusion additive manufacturing process. The high accuracy is required so that the device carrying out the additive manufacturing process does not collide with the already manufactured article once the additive manufacturing process is continued.

After the sensor construction 1 is inserted in the space 11, the manufacturing process of the article 10 is continued until the article is ready, as shown in FIG. 2B. During the continued manufacturing process after inserting of the sensor construction 1 a hole 12 is formed extending from the space 11 to the outer surface of the article 10, which hole is straight as well as parallel and concentric with the corresponding hole 4 in the sensor construction 1.

As a last step a RFID antenna 13 is connected to the sensor 2 of the sensor construction 1 inside the article 10 with a pin 14 by inserting the pin through the holes 12 and 4 into connection provided at the sensor 2 inside the sensor construction 1, and the antenna is attached at the surface of the article. The end of the pin 14 comprises a suitable plug which, when the pin is inserted in the holes 12 and 4, aligns itself for insertion into a corresponding socket in the sensor 2, and the connection is achieved with an inserting movement of the pin 14 and the plug therein through the holes 12 and 4.

The antenna 13 allows wireless transmitting of the data collected by the sensor 2 to suitable collection, storage and/or analysis devices (not shown).

The article 10 is advantageously part of a larger assembly or device, wherein the surface in which the antenna 13 is located forms outer surface or is sufficiently close to the outer surface, so that the material of the larger assembly or device does not block the signal from the antenna. Alternatively, the antenna 13 can be replaced with wiring for transferring the collected data from the sensor to outside the article 10.

The specific exemplifying embodiments of the invention shown in figures and discussed above should not be construed as limiting. A person skilled in the art can amend and modify the embodiments described in many evident ways within the scope of the attached claims. Thus, the invention is not limited merely to the embodiments described above.

1. Sensor construction, which construction comprises a sensor, wherein the sensor construction comprises a heat insulating material cover for embedding the sensor construction inside metal material of a component, inside which heat insulating material cover the sensor is located, and which heat insulating material cover comprises a level surface section for correct positioning of the sensor construction inside the component during powder bed fusion additive manufacturing process of the component, and a hole extending as a substantially straight channel from the outer surface of the heat insulating material cover to the sensor inside the heat insulating material cover.

2. Sensor construction according to claim 1, wherein the heat insulating material cover is formed from two or more parts, which parts are assembled together to form the heat insulating material cover, during which assembling the sensor is inserted inside the heat insulating material cover.

3. Sensor construction according to claim 1, wherein the heat insulated material cover is formed as a single piece with additive manufacturing process, during which manufacturing process the sensor is inserted inside the heat insulating material cover.

4. Sensor construction according to claim 1, wherein on the level surface section of the heat insulating material is added a metal layer, preferably in the form of a sheet metal piece or metal coating.

5. Sensor construction according to claim 1, wherein the material of the heat insulating material cover is ceramics.

6. Sensor construction according to claim 1, wherein the heat insulating material cover comprises a spherical section.

7. Sensor construction according to claim 1, wherein the sensor is MEMS sensor.

8. Sensor construction according to claim 1, wherein the sensor construction comprises devices for transmitting data from the sensor, which devices are located outside the heat insulating material cover and connected to the sensor via the straight hole in the heat insulating material cover.

9. Method for manufacturing an article with an embedded sensor, in which method the article is manufactured with a powder bed fusion additive manufacturing process from metal material, characterized in that
the sensor is a sensor of a sensor construction according to claim 1 with a level surface section,
in the article manufactured is formed a space for the sensor construction, which space corresponds the shape and size of the sensor construction,
the additive manufacturing process is interrupted when the space for the sensor construction is formed with the exception of its upper surface,
the sensor construction is inserted in the formed space so that the sensor construction fills substantially the whole formed space, and its level surface section is substantially flush with the manufacturing surface of the article, and the additive manufacturing process is continued until the article is ready,
during the additive manufacturing process of the article a substantially straight hole is formed, which hole extends from the space for the sensor construction to the outer surface of the article, and which hole in the manufactured article is substantially parallel and concentric with the hole in the sensor construction inside the article, and
data transmitting devices are connected to the sensor via the hole in the article and the hole in the sensor construction.

10. Method according to claim 9, wherein the accuracy of the dimensioning of the space for the sensor construction is less than the powder thickness of the powder bed fusion additive manufacturing process.
